(19) United States
(12) Patent Application Publication
(10) Pub. No.: US 2005/0256977 A1
(43) Pub. Date: Nov. 17, 2005

(54) Integrated circuit having processor and switch capabilities

(76) Inventors: Eric J. Dehaemer, Shrewsbury, MA (US); Mark A. Schmisseur, Phoenix, AZ (US); Deif N. Atallah, Chandler, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/846,458

(22) Filed: May 14, 2004

(51) Int. Cl. G06F 13/14

(52) U.S. Cl. 710/5

(57) ABSTRACT

An apparatus according to one embodiment may include an integrated circuit. The integrated circuit may include a processor and a switch. The switch may include at least one port capable of being coupled to at least one external communication link. The processor may be capable of issuing a request to the switch to request that the switch block forwarding via the at least one port of a command received by the switch. The switch may be capable of issuing to an issuer of the command, in response at least in part to receipt by the switch of the command, a response indicating absence of the at least one port from the switch. Of course, many alternatives, variations, and modifications are possible without departing from this embodiment.

### FIELD

This disclosure relates to an integrated circuit having processor and switch capabilities.

### BACKGROUND

In one conventional data storage arrangement, a host includes a plurality of host processors coupled to a memory hub system. The memory hub system is also coupled via a communication link to a switch. The switch is coupled, via additional respective communication links, to an input/output (I/O) processor and to an I/O controller. The I/O controller is also coupled to a redundant array of inexpensive disks.

In this conventional arrangement, the host processors, memory hub system, switch, and I/O processor each comprise a separate, respective integrated circuit chip. In operation, a host processor may issue to the I/O processor, and/or the I/O processor may issue to a host processor data and/or commands. Such data and/or commands propagate through the switch. This introduces propagation delay in the transmission, and/or reduces the maximum possible transmission bandwidth, of such data and/or commands in this conventional arrangement. Additionally, in this conventional arrangement, a host processor configures and controls the I/O controller. There is no mechanism, in this conventional arrangement, to permit the I/O processor, instead of this host processor, to be able to configure and/or control, at least in part, the I/O controller.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 is a diagram illustrating a system embodiment.

FIG. 2 is a flowchart illustrating operations that may be performed according to an embodiment.

Although the following Detailed Description will proceed with reference being made to illustrative embodiments, many alternatives, modifications, and variations thereof will be apparent to those skilled in the art. Accordingly, it is intended that the claimed subject matter be viewed broadly, and be defined only as set forth in the accompanying claims.

### DETAILED DESCRIPTION

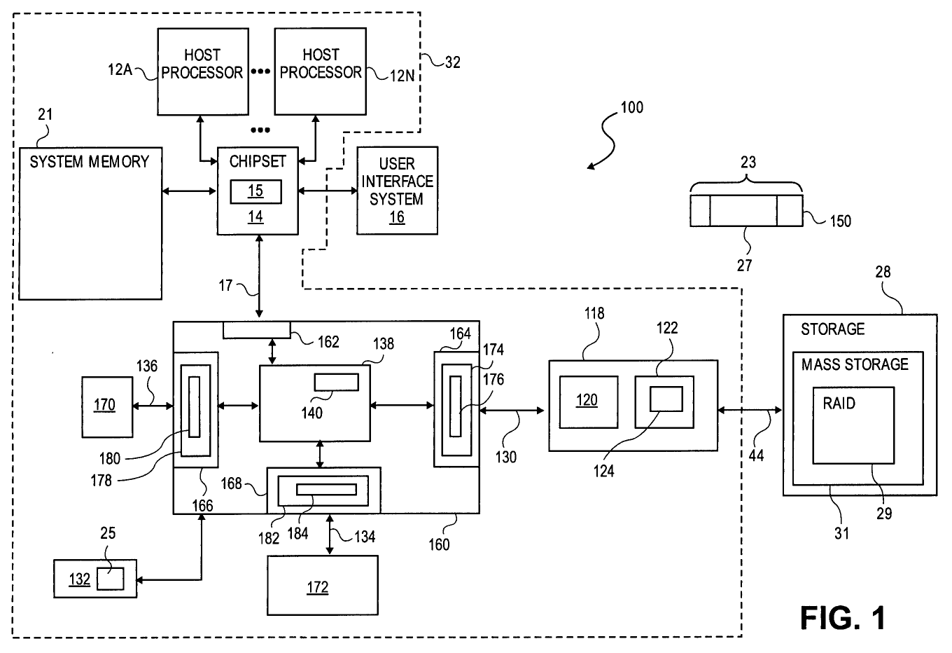

FIG. 1 illustrates a system embodiment 100. System 100 may include one or a plurality of host processors 12A . . . 12N. Each of the host processors 12A . . . 12N may be coupled to a chipset 14. Each host processor 12A . . . 12N may comprise, for example, a respective Intel® Pentium® 4 microprocessor that is commercially available from the Assignee of the subject application. Of course, alternatively, each of the host processors 12A . . . 12N may comprise, for example, a respective microprocessor that is manufactured and/or commercially available from a source other than the Assignee of the subject application, without departing from this embodiment.

Chipset 14 may comprise a memory controller hub 15 that may comprise a host bridge/hub system that may couple host processors 12A . . . 12N, a system memory 21 and a user interface system 16 to each other and to a communication link 17. Chipset 14 may comprise one or more integrated circuit chips selected from, for example, one or more integrated circuit chipsets available from the Assignee of the subject application (e.g., memory controller hub and I/O controller hub chipsets), although one or more other integrated circuit chips may also, or alternatively be used, without departing from this embodiment. User interface system 16 may comprise, e.g., a keyboard, pointing device, and display system that may permit a human user to input commands to, and monitor the operation of, system 100.

Communication link 17 may comprise a communication link that complies with the protocol described in Peripheral Component Interconnect (PCI) Express™ Base Specification Revision 1.0, published Jul. 22, 2002, available from the PCI Special Interest Group, Portland, Oreg., U.S.A. (hereinafter referred to as a “PCI Express™ link”). Alternatively, link 17 instead may comprise another type of communication link, including, for example, another type of bus system, without departing from this embodiment.

Circuitry 118 may be coupled to and control the operation of storage 28. In this embodiment, storage 28 may comprise mass storage 31 that may comprise, e.g., one or more redundant arrays of independent disks (RAID) 29. The RAID level that may be implemented by RAID 29 may be 0, 1, or greater than 1. Depending upon, for example, the RAID level implemented in RAID 29, the number of storage devices comprised in RAID 29 may vary so as to permit the number of such storage devices to be at least sufficient to implement the RAID level implemented in RAID 29.

As used herein, the terms “storage” and “storage device” may be used interchangeably to mean one or more apparatus into, and/or from which, data may be stored and/or retrieved, respectively. Also, as used herein, the term “mass storage” means storage capable of non-volatile storage of data. For example, in this embodiment, mass storage may include, without limitation, one or more non-volatile magnetic, optical, and/or semiconductor storage devices. As used herein, “circuitry” may comprise, for example, singly or in any combination, analog circuitry, digital circuitry, hardwired circuitry, programmable circuitry, state machine circuitry, and/or memory that may comprise program instructions that may be executed by programmable circuitry.

In this embodiment, circuitry 118 may comprise storage I/O controller 120 and memory 122. Circuitry 118 may be coupled to integrated circuit 160 via a communication link, such as, for example, PCI Express™ link 130. As used herein, an “integrated circuit” means a semiconductor device and/or microelectronic device, such as, for example, a semiconductor integrated circuit chip. Integrated circuit 160 may be coupled via link 17 to chipset 14. System 100 also may comprise one or more additional devices, such as, for example, circuitry 170 and 172 that may be coupled to integrated circuit 160 via communication links 136 and 134, respectively. In this embodiment, links 136 and 134 may comprise PCI Express™ links. Links 17, 130, 134, and/or 136 may be external to integrated circuit 160 and/or switch fabric 138.

Integrated circuit 160 also may be coupled to memory 132. Alternatively, without departing from this embodiment, integrated circuit 160 may comprise memory 132.

Processors 12A . . . 12N, system memory 21, chipset 14, integrated circuit 160, circuitry 170, circuitry 172, circuitry 118, links 17, 130, 134, and 136, and memory 132 may be comprised in a single circuit board, such as, for example, a system motherboard 32. Storage 28 may be comprised in one or more respective enclosures that may be separate from the enclosure in which the motherboard 32 and the components comprised in the motherboard 32 are enclosed.

Circuitry 118 may be coupled to storage 28 via one or more communication links 44. When circuitry 118 is so coupled to storage 28, controller 120 also may be coupled to storage 28 via one or more links 44. One or more links 44 may be compatible with one or more communication protocols, and circuitry 118 and/or controller 120 may exchange data and/or commands with storage 28, via links 44, in accordance with these one or more communication protocols. For example, one or more links 44 may be compatible with, and circuitry 118 and/or controller 120 may exchange data and/or commands with storage 28 via links 44 in accordance with, e.g., a Fibre Channel (FC) protocol, Small Computer Systems Interface (SCSI) protocol, Ethernet protocol, Transmission Control Protocol/Internet Protocol (TCP/IP) protocol, Serial Advanced Technology Attachment (S-ATA) protocol and/or Serial Attached Small Computer Systems Interface (SAS) protocol. Of course, alternatively, one or more links 44 may be compatible with, and/or circuitry 118 and/or controller 120 may exchange data and/or commands with storage 28 in accordance with other and/or additional communication protocols, without departing from this embodiment.

In accordance with this embodiment, if one or more links 44 are compatible with, and/or circuitry 118 and/or controller 120 exchange data and/or commands with storage 28 in accordance with FC protocol, the FC protocol may comply or be compatible with the interface/protocol described in ANSI Standard Fibre Channel (FC) Physical and Signaling Interface-3 X3.303:1998 Specification. Alternatively or additionally, if one or more links 44 are compatible with, and/or circuitry 118 and/or controller 120 exchange data and/or commands with storage 28 in accordance with SCSI protocol, the SCSI may comply or be compatible with the protocol described in American National Standards Institute (ANSI) Small Computer Systems Interface-2 (SCSI-2) ANSI X3.131-1994 Specification. Also alternatively or additionally, if one or more links 44 are compatible with, and/or circuitry 118 and/or controller 120 exchange data and/or commands with storage 28 in accordance with an Ethernet protocol, the Ethernet protocol may comply or be compatible with the protocol described in Institute of Electrical and Electronics Engineers, Inc. (IEEE) Std. 802.3, 2000 Edition, published on Oct. 20, 2000. Further alternatively or additionally, if one or more links 44 are compatible with, and/or circuitry 118 and/or controller 120 exchange data and/or commands with storage 28 in accordance with TCP/IP protocol, the TCP/IP protocol may comply or be compatible with the protocols described in Internet Engineering Task Force (IETF) Request For Comments (RFC) 791 and 793, published September 1981. Also alternatively or additionally, if one or more links 44 are compatible with, and/or circuitry 118 and/or controller 120 exchange data and/or commands with storage 28 in accordance with an S-ATA protocol, the S-ATA protocol may comply or be compatible with the protocol described in “Serial ATA: High Speed Serialized AT Attachment,” Revision 1.0, published on Aug. 29, 2001 by the Serial ATA Working Group. Further alternatively or additionally, if one or more links 44 are compatible with, and/or circuitry 118 and/or controller 120 exchange data and/or commands with storage 28 in accordance with SAS protocol, the SAS may comply or be compatible with the protocol described in “Information Technology—Serial Attached SCSI (SAS),” Working Draft American National Standard of International Committee For Information Technology Standards (INCITS) T10 Technical Committee, Project T10/1562-D, Revision 2b, published 19 Oct. 2002, by American National Standards Institute.

Machine-readable program instructions may be stored in memory 122. In operation of system 100, these instructions may be accessed and executed by controller 120. When executed by controller 120, these instructions may result in controller 120 and/or operative circuitry 118 performing the operations described herein as being performed by controller 120 and/or operative circuitry 118. Memory 122 may comprise one or more configuration information registers 124 that may store information that may indicate, relate to, and/or be used to facilitate the configuration and/or control of circuitry 118, controller 120, one or more devices comprised in circuitry 118, and/or one or more operations and/or features of circuitry 118 and/or controller 120. As used herein, a first device may be considered to be controlled or under the control of a second device, if the second device may supply one or more signals to the first device that may result in change and/or modification, at least in part, of first device's operation. Also as used herein, the configuring of such a first device by such a second device may comprise the supplying by the second device of one or more signals that may be result in selection, change, and/or modification of one or more values and/or parameters stored in the first device that may result in change and/or modification of at least one operational characteristic and/or mode of the first device.

Memories 132 and/or 21 each may comprise one or more of the following types of memories: semiconductor firmware memory, programmable memory, non-volatile memory, read only memory, electrically programmable memory, random access memory, flash memory, magnetic disk memory, and/or optical disk memory. For example, in this embodiment, memory 132 may comprise double data rate (DDR) synchronized dynamic random access memory (SDRAM). Either additionally or alternatively, memories 132 and/or 21 each may comprise other and/or later-developed types of computer-readable memory.

Integrated circuit 160 may be or comprise a switch that may comprise I/O processor 140, switch fabric 138, and one or more ports, for example, port circuitry 162, 164, 166, and 168. Switch fabric 138 may comprise processor 140. Alternatively, without departing from this embodiment, processor 140 may be comprised in integrated circuit 160, coupled to switch 138, but may not be comprised in switch fabric 138.

As used herein, a “switch” comprises first circuitry capable of forwarding, at least in part, to second circuitry one or more packets received by the first circuitry from third circuitry. Also as used herein, a “packet” means a sequence of one or more signals that encode one or more symbols and/or values. As used herein, “forwarding” one or more packets by, from, or via circuitry means transmitting by, from, or via, respectively, the circuitry the one or more packets to other circuitry. In this embodiment, the switch that may be or be comprised in integrated circuit 160, and/or switch fabric 138 may be or comply and/or be compatible with communication protocol described in, for example, the PCI Express™ Base Specification Revision 1.0, published Jul. 22, 2002, available from the PCI Special Interest Group, Portland, Oreg., U.S.A (hereinafter, a “PCI-Express™ switch”). Of course, without departing from this embodiment, the switch that may be or be comprised in integrated circuit 160, and/or switch fabric 138 may comply and/or be compatible with one or more other protocols.

In this embodiment, switch fabric 138 may be coupled to port circuitry 162, port circuitry 164, port circuitry 166, and port circuitry 168. Port circuitry 164 may comprise bridge circuitry 174 that may comprise one or more control and/or configuration registers 176. Port circuitry 166 may comprise bridge circuitry 178 that may comprise one or more control and/or configuration registers 180. Port circuitry 168 may comprise bridge circuitry 182 may comprise one or more control and/or configuration registers 184. Without departing from this embodiment, although not shown in the Figures, switch fabric 138 may comprise ports 162, 164, 166, and/or 168. Also without departing from this embodiment, registers 176, 178, and/or 184 may not be comprised in ports 164, 166, and/or 168, but instead, may be comprised in switch 138 and/or elsewhere in integrated circuit 160. One or more values stored in registers 176, 178, and/or 184 may control, at least in part, operation of operative circuitry in ports 164, 166, and/or 168.

As used herein, a “processor” means circuitry capable of performing, at least in part, one or more arithmetic and/or logical operations. Also as used herein, an “I/O processor” means a processor capable of performing, at least in part, one or more operations that may facilitate and/or result in, at least in part, one or more storage and/or I/O operations and/or one or more operations related to and/or associated with, at least in part, one or more storage and/or I/O operations. In this embodiment, I/O processor 140 may comprise a general purpose processor (not shown), and memory that is capable of being accessed by the general purpose processor. Also, although not shown in the Figures, port circuitry 162 may comprise bridge circuitry that may comprise one or more control and/or configuration registers.

Machine-readable program instructions may be stored in memory 132 and/or memory 21. In operation of system 100, these instructions may be accessed and executed by processor 140 and/or one or more of the host processors 12A . . . 12N. When executed by processor 140 and/or one or more of the host processors 12A . . . 12N, these instructions may result in processor 140, integrated circuit 160, one or more host processors 12A . . . 12N, and/or system 100 performing the operations described herein as being performed by processor 140, integrated circuit 160, one or more host processors 12A . . . 12N, and/or system 100.

As stated previously, in this embodiment, integrated circuit 160 and circuitry 118 may be comprised in circuit board 32. Alternatively, without departing from this embodiment, circuit board 32 may comprise a bus interface slot (not shown) that may be coupled to link 17, and integrated circuit 160 may be comprised in a circuit card (not shown) that may be capable of being inserted into this bus interface slot. In this alternative arrangement, when this card is properly inserted into this slot, port circuitry 162 may become coupled to link 17, and integrated circuit 160 may be capable of exchanging data and/or commands with system memory 21, one or more host processors 12A . . . 12N, and/or user interface system 16 via link 17 and chipset 14.

Additionally or alternatively, system 100 may comprise a bus interface slot (not shown) that may be coupled to link 130, and circuitry 118 may be or be comprised in a circuit card that may be capable of being inserted into this bus interface slot. When the card that comprises circuitry 118 is so inserted into this bus interface slot, circuitry 118 may become coupled to link 130 and may be capable of exchanging data and/or commands with integrated circuit 160. In this arrangement, if integrated circuit 160 is comprised in a circuit card, the bus interface slot into which the circuit card that comprises circuitry 118 may be inserted, may be comprised in the circuit card that comprises integrated circuit 160. Further alternatively, circuitry 118, controller 120, memory 122, and/or configuration information registers 124 may be comprised, at least in part, in integrated circuit 160.

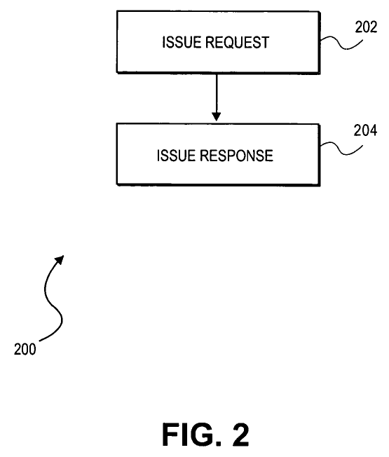

FIG. 2 is flowchart illustrating operations 200 that may be performed in system 100 according to an embodiment. In this embodiment, after, for example, a reset of system 100, one or more of the host processors 12A . . . 12N (e.g., host processor 12A) may transmit via chipset 14 and link 17 one or more host configuration read requests, in accordance with, for example, the protocol with which link 17 may be compatible, requesting configuration information of devices that may be accessible via link 17, in order to enable host processor 12A to configure and/or control such devices.

In this embodiment, integrated circuit 160 may receive one or more such configuration read requests from host processor 12A. In response, at least in part, to receipt of one or more such configuration read requests, I/O processor 140 may signal integrated circuit 160 and/or switch fabric 138. This may result in integrated circuit 160 and/or switch 138 issuing retry responses, in accordance with the protocol with which link 17 may be compatible, via port 162 and link 17. This may result in host processor 12A being prevented, at least temporarily, from configuring integrated circuit 160, processor 140, fabric 138, circuitry 118, controller 120, port circuitry 164, port circuitry 166, port circuitry 168, circuitry 170, and/or circuitry 172.

This signaling of integrated circuit 160 and/or switch fabric 138 by processor 140 also may result in integrated circuit 160 and/or switch fabric 138 scanning links 130, 136, and 134, in accordance with the protocol with which links 130, 136, and 134 may comply, to permit processor 140 to discover, in accordance with this protocol, devices coupled to links 130, 136, and 134 that may be controllable and/or configurable by processor 140. For example, as part of the scan of link 130, integrated circuit 160 may transmit via link 130 to operative circuitry 118 and/or controller 120 one or more configuration read requests in accordance with the protocol with which link 130 may comply. This may result in operative circuitry 118 and/or controller 120 reading the configuration information stored in one or more registers 124, and transmitting one or more configuration read responses to integrated circuit 160 and/or processor 140 via link 130. These one or more configuration read responses may comprise and/or indicate the configuration information read from one or more registers 124. Based at least in part upon this configuration information, processor 140 may determine and/or discover, at least in part, in accordance with the protocol with which link 130 may comply, operative circuitry 118 and/or controller 120, and/or the configuration, operation, and/or features of card 102, operative circuitry 118, and/or controller 120.

As used herein, a first device may be considered to be “configurable” by a second device, if the second device is capable, at least in part, of controlling and/or selecting at least one feature, mode, and/or characteristic of operation of the first device. As used herein, a “scan” involves the issuance of one or more requests (such as, for example, configuration read requests) via one or more communication links to obtain one or more responses (such as, for example, configuration read responses) that may be, and/or contain information indicative of the existence, characteristics, type, and/or operation of one or more devices accessible via the link.

Contemporaneously, before, or after the signaling of integrated circuit 160 by processor 140, the processor 140 may issue to integrated circuit 160 and/or switch 138 a request, as illustrated by operation 202 in FIG. 2, that the integrated circuit 160 and/or switch 138 block forwarding via at least one of the ports (e.g., port 164) of a command, received at the integrated circuit 160 and/or switch 138 from host processor 12A. For example, in this embodiment, in response, at least in part, to the receipt of this request by integrated circuit 160 and/or switch 138, one or more values may be stored in one or more control registers 176. Thereafter, integrated circuit 160 and/or switch 138 may receive a command (e.g., in this embodiment, a host configuration read request) from host processor 12A via link 17 and port 162. In this embodiment, the storing of the one or more values in one or more control registers 176 may result in integrated circuit 160, switch 138, bridge 174, and/or port 164 blocking the forwarding of (e.g., not forwarding) the command via port 164 to link 130; this may prevent the command from being received by circuitry 118 and/or controller 120. The storing of these one or more values in one or more control registers 176 also may result in the issuing from the integrated circuit 160 and/or switch 138, via port 162 and link 17, to an issuer of the command (e.g., host processor 12A), in response at least in part to receipt of the command by integrated circuit 160 and/or switch 138, a null response, as illustrated by operation 204 in FIG. 2. This null response may be in accordance with the protocol with which link 17 may comply, and may indicate to the host processor 12A that at least one port 164 is absent from the switch 138 and/or integrated circuit 160, and/or that no device is coupled to port 164 via link 130. Effectively, this may prevent host processor 12A from discovering and/or configuring circuitry 118 and/or controller 120.

After processor 140 has determined and/or discovered, at least in part, operative circuitry 118, controller 120, and/or the configuration, operation, and/or features circuitry 118 and/or controller 120, processor 140 may signal integrated circuit 160 and/or switch fabric 138. This may result in integrated circuit 160 and/or switch 138 issuing to circuitry 118 via link 130 one or more requests to write one or more values into one or more registers 124 that may facilitate and/or permit control, at least in part, of operative circuitry 118 and/or controller 120 by processor 140; this also may result in integrated circuit 160 and/or switch 138 issuing to circuitry 118 via link 130 one or more queries to operative circuitry 118 and/or controller 120 requesting that operative circuitry 118 and/or controller 120 provide processor 140 with an indication of resources (e.g., in this embodiment, a size of address space comprising addresses of link 17) in system 100 that operative circuitry 118 and/or controller 120 requests be assigned to operative circuitry 118 and/or controller 120. In response, at least in part, to these one or more requests and/or queries, operative circuitry 118 and/or controller 120 may write these one or more values into one or more registers 124, and/or may provide to processor 140 a request for assignment of such resources to operative circuitry 118 and/or controller 120. This request may include an indication of the resources that operative circuitry 118 and/or controller 120 requests be assigned to operative circuitry 118 and/or controller 120.

Thereafter, based at least in part upon this indication provided to processor 140, the configuration information comprised in one or more configuration read responses from operative circuitry 118 and/or controller 120, and/or configuration information stored in integrated circuit 160 and associated with integrated circuit 160, processor 140, switch 138, and/or port 164, processor 140 may determine a total set of resources in system 100 that processor 140 may request be assigned by host 12A to permit integrated circuit 160, processor 140, switch 138, port 164, operative circuitry 118, and/or controller 120 to be properly configured and to operate appropriately. As used herein, a “resource” of a system may include a facility, instrumentality, and/or identifier for such facility and/or instrumentality in the system that may be allocated (e.g., granted) from a pool of facilities, instrumentalities, and/or identifiers, for use by and/or association with one or more devices in the system.

Thereafter, processor 140 may signal integrated circuit 160 and/or switch fabric 138. This may result in integrated circuit 160 and/or switch fabric 138 no longer issuing retry responses in accordance with the protocol with which link 17 may be compatible. Subsequently, host processor 12A may issue via link 17 a host configuration read request that may be received by integrated circuit 160 and/or switch fabric 138. In response, at least in part, to the host configuration read request received by integrated circuit 160 and/or switch fabric 138, processor 140 may signal integrated circuit 160 and/or switch 138. This may result in integrated circuit 160 and/or switch 138 providing to host processor 12A configuration information that may include configuration information associated with integrated circuit 160, processor 140, switch 138, and/or port 164, and appropriate configuration information previously obtained by processor 140 from one or more registers 124 to permit integrated circuit 160, processor 140, switch 138, port 164, operative circuitry 118, and/or controller 120 to be properly configured and to operate appropriately.

Processor 12A thereafter may issue to integrated circuit 160, processor 140, port 164, and/or switch 138 via link 17 one or more requests to write one or more values into one or more control registers (not shown) in integrated circuit 160, processor 140, port 164, and/or switch 138 that may facilitate and/or permit control, at least in part, of integrated circuit 160, processor 140, port 164, and/or switch 138 by host processor 12A. In response, at least in part, to these one or more write requests, integrated circuit 160, processor 140, port 164, and/or switch 138 may write into these one or more registers these one or more values. Processor 12A also may issue to integrated circuit 160, processor 140, port 164, and/or switch 138 via link 17 one or more queries requesting that integrated circuit 160, processor 140, port 164, and/or switch 138 provide processor 12A with an indication of resources (e.g., in this embodiment, a size of an address space comprising addresses of link 17) in system 100 that integrated circuit 160, processor 140, port 164, and/or switch 138 request be assigned to integrated circuit 160, processor 140, port 164, and/or switch 138. In response, at least in part, to these one or more queries, integrated circuit 160, processor 140, port 164, and/or switch 138 may transmit to processor 12A via link 17 a request to be allocated the total set of resources in system 100 that processor 140 previously determined should be assigned by host 12A to permit circuit 160, processor 140, switch 138, port 164, operative circuitry 118, and/or controller 120 to be properly configured and to operate appropriately. This request may include an indication of this total set of resources whose allocation is being requested. Thus, this request may be based, at least in part upon a subset of the total set of resources, which subset comprises resources was previously requested by circuitry 118 and/or controller 120 to be assigned to circuitry 118 and/or controller 120.

Thereafter, based at least in part upon this indication provided to processor 12A and the configuration information previously provided to processor 12A by integrated circuit 160, processor 140, switch 138, and/or port 164, processor 12A may determine to assign to integrated circuit 160, processor 140, switch 138, and/or port 164 the total set of resources requested by integrated circuit 160, processor 140, switch 138, and/or port 164. For example, in this embodiment, if this total set of resources comprises a size of an address space comprising addresses of link 17, processor 12A may assign to integrated circuit 160, processor 140, switch 138, and/or port 164 an address space (shown symbolically by structure 23 in FIG. 1) comprising addresses of link 17. Processor 12A thereafter may provide to processor 140 via link 17 one or more values that may indicate and/or specify address space 23. Thereafter, processor 140 may assign to operative circuitry 118 and/or controller 120 one or more subsets of the total set of resources assigned by processor 12A to integrated circuit 160, processor 140, switch 138, and/or port 164.

For example, in this embodiment, after processor 12A has provided the one or more values to processor 140 that may indicate and/or specify address space 23, processor 140 may execute in memory 132 one or more program processes 25. The execution by processor 140 of these one or more program processes 25 may result in processor 140 assigning to integrated circuit 160, processor 140, switch 138, and/or port 164 one or more subsets 27 of space 23. The execution by processor 140 of these one or more program processes 25 also may result in processor 140 assigning to operative circuitry 118 and/or controller 120 one or more subsets 150 of space 23. Processor 140 may make the assignments of subsets 27 and/or 150, based at least in part upon the previously provided indications of the resources whose assignment was requested by circuit 160, processor 140, switch 138, port 164, operative circuitry 118, and/or controller 120 and/or the configuration information comprised in the one or more configuration read responses provided by circuit 160, processor 140, switch 138, port 164, operative circuitry 118, and/or controller 120. Processor 140 may store in one or more registers (not shown) in integrated circuit 160, switch 138, processor 140, and/or port 164 one or more values that may indicate and/or specify one or more subsets 27. Additionally, processor 140 may provide to operative circuitry 118 and/or controller 120 via link 130 one or more other values that may indicate and/or specify one or more subsets 150. Thereafter, integrated circuit 160, processor 140, switch 138, and/or port 164 may utilize (e.g., claim and/or be accessible via) one or more subsets 27 in accordance with the assignment of resources made by processor 140 to integrated circuit 160, processor 140, switch 138, and/or port 164; operative circuitry 118 and/or controller 120 may utilize (e.g., claim and/or be accessible via) one or more subsets of 150 in accordance with the assignment of resources made by processor 140 to operative circuitry 118 and/or controller 120.

After processor 12A has ceased issuing configuration read requests via link 17, processor 12A may signal integrated circuit 160. This may result in processor 140 issuing a request to switch 138 that port 164 forward via link 130 commands and/or data received by link 17 that are destined for circuitry 118 and/or controller 120. Thereafter, circuitry 118 and/or controller 120 may exchange data and/or commands, via integrated circuit 160 with components of system 100 that may be coupled to link 17.

Also after processor 12A has ceased issuing configuration read requests via link 17, processor 12A may issue to integrated circuit 160 one or more requests to store in and/or retrieve data from storage 28. This may result in processor 140 issuing one or more commands to controller 120 via link 130 that may result in controller 120 issuing to storage 28 one or more commands via one or more links 44. In response, at least in part, to these one or more commands from controller 120, storage 28 may store data in and/or retrieve data from storage 28, as per the one or more requests from processor 12A. Such data retrieved from storage 28 may be transmitted via one or more links 44 to operative circuitry 118, and thence, may be transmitted by operative circuitry 118 to integrated circuit 160. Thereafter, integrated circuit 160 may provide the retrieved data to processor 12A as per the one or more requests issued by processor 12A.

Alternatively, without departing from this embodiment, if it is desired that processor 12A be permitted to configure and/or control, at least in part, operative circuitry 118 and/or controller 120, instead of issuing to integrated circuit 160 and/or switch 138 a request that integrated circuit 160 and/or switch 138 block forwarding of one or more commands received by the integrated circuit 160 and/or switch 138 from host processor 12A from being forwarded from switch 138 via link 130, after a reset of system 100, processor 140 may request that integrated circuit 160 and/or switch 138 forward such commands via link 130. In this alternate arrangement, integrated circuit 160 and/or switch 138 may not issue to processor 12A retry responses in response to configuration read requests received by integrated circuit 160 and/or switch 138 from processor 12A. In this alternate arrangement, this may permit host processor 12A to configure and/or control, at least in part, operative circuitry 118 and/or controller 120. By utilizing substantially similar operations to those described above, circuitry 170 and/or 172 may be either configured and/or controlled, at least in part, by host processor 12A, or may be prevented from being configured and/or controlled, at least in part, by host processor 12A.

Thus, in summary, one system embodiment may comprise a circuit board comprising a first processor and a hub. The hub may be coupled to the first processor and to a first communication link. The system of this embodiment also may comprise a circuit card comprising a device capable of being coupled to a second communication link, and an integrated circuit. The integrated circuit may comprise a second processor and a switch. The switch may comprise a plurality of ports. The plurality of ports may comprise a first port and a second port. The first port may be capable of being coupled to the first communication link. The second port may be capable of being coupled to the second communication link. The second processor may be capable of issuing a request to the switch to request that the switch block forwarding via the second port of a command received at the first port. The switch may be capable of issuing to an issuer of the command, in response at least in part to receipt at the first port of the command, a response indicating absence of the second port from the switch.

Advantageously, in this system embodiment, both the second processor and the switch may be comprised in a single integrated circuit. This may permit reduction in propagation delay in the transmission, and/or increase the maximum possible transmission bandwidth, of such data and/or commands in this system embodiment, compared to the prior art. Additionally, the features of this system embodiment may permit the second processor to be able to configure and/or control, at least in part, the device, and also may prevent the first processor from being able to configure and/or control, at least in part, the device. This may permit the second processor to be able to configure and/or control, at least in part, the device, independently, at least in part, from the first processor.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Indeed, without departing from this embodiment, system 100 may include more or fewer than the elements shown in the Figures and described previously herein as being comprised system 100. Accordingly, the claims are intended to cover all such equivalents.

1. An apparatus comprising:
an integrated circuit comprising a processor and a switch, the switch comprising at least one port capable of being coupled to at least one external communication link, the processor being capable of issuing a request to the switch to request that the switch block forwarding via the at least one port of a command received by the switch, the switch being capable of issuing to an issuer of the command, in response at least in part to receipt by the switch of the command, a response indicating absence of the at least one port from the switch.

2. The apparatus of claim 1, wherein:
the processor comprises an input/output (I/O) processor;
the at least one port is capable of being coupled to a Peripheral Component Interconnect (PCI)-Express link; and
the switch comprises a PCI-Express switch.

3. The apparatus of claim 1, wherein:
the command comprises a host configuration read request;
the response comprises a null response; and
the issuer comprises a host processor.

4. The apparatus of claim 1, wherein:
the processor is capable of discovering, at least in part, at least one device coupled to the at least one port.

5. The apparatus of claim 4, wherein:
the processor also is capable of configuring, at least in part, the at least one device.

6. The apparatus of claim 4, wherein:
the processor also is capable of assigning to the at least one device a subset of resources allocated by a host processor.

7. The apparatus of claim 4, wherein:
the switch comprises another port; and
the processor also is capable of issuing to a host processor via the another port a request for resources, the request for resources being based at least in part upon resources to be assigned to the at least one device.

8. A method comprising:
issuing, from a processor, a request to a switch, an integrated circuit comprising the processor and the switch, the switch comprising at least one port capable of being coupled to at least one external communication link, the request requesting that that the switch block forwarding via the at least one port of a command received by the switch; and
issuing, from the switch, to an issuer of the command, in response at least in part to receipt by the switch of the command, a response indicating absence of the at least one port from the switch.

9. The method of claim 8, wherein:
the processor comprises an input/output (I/O) processor;
the at least one port is capable of being coupled to a Peripheral Component Interconnect (PCI)-Express link; and
the switch comprises a PCI-Express switch.

10. The method of claim 8, wherein:
the command comprises a host configuration read request;
the response comprises a null response; and
the issuer comprises a host processor.

11. The method of claim 8, wherein:
the processor is capable of discovering, at least in part, at least one device coupled to the at least one port.

12. The method of claim 11, wherein:
the processor also is capable of configuring, at least in part, the at least one device.

13. The method of claim 11, wherein:
the processor also is capable of assigning to the at least one device a subset of resources allocated by a host processor.

14. The method of claim 11, wherein:
the switch comprises another port; and
the processor also is capable of issuing to a host processor via the another port a request for resources, the request for resources being based at least in part upon resources to be assigned to the at least one device.

15. An article comprising:
a storage medium storing instructions that when executed by a machine result in the following:
issuing, from a processor, a request to a switch, an integrated circuit comprising the processor and the switch, the switch comprising at least one port capable of being coupled to at least one external communication link, the request requesting that that the switch block forwarding via the at least one port of a command received by the switch; and
issuing, from the switch, to an issuer of the command, in response at least in part to receipt by the switch of the command, a response indicating absence of the at least one port from the switch.

16. The article of claim 15, wherein:
the processor comprises an input/output (I/O) processor;
the at least one port is capable of being coupled to a Peripheral Component Interconnect (PCI)-Express link; and
the switch comprises a PCI-Express switch.

17. The article of claim 15, wherein:
the command comprises a host configuration read request;
the response comprises a null response; and
the issuer comprises a host processor.

18. The article of claim 15, wherein:
the processor is capable of discovering, at least in part, at least one device coupled to the at least one port.

19. The article of claim 18, wherein:
the processor also is capable of configuring, at least in part, the at least one device.

20. The article of claim 18, wherein:
the processor also is capable of assigning to the at least one device a subset of resources allocated by a host processor.

21. The article of claim 18, wherein:
the switch comprises another port; and
the processor also is capable of issuing to a host processor via the another port a request for resources, the request for resources being based at least in part upon resources to be assigned to the at least one device.

22. A system comprising:
a circuit board comprising a first processor and a hub, the hub being coupled to the first processor and to a first communication link;
a circuit card comprising a device capable of being coupled to a second communication link; and
an integrated circuit comprising a second processor and a switch, the switch comprising a plurality of ports, the plurality of ports comprising a first port and a second port, the first port being capable of being coupled to the first communication link, the second port being capable of being coupled to the second communication link, the second processor being capable of issuing a request to the switch to request that the switch block forwarding via the second port of a command received at the first port, the switch being capable of issuing to an issuer of the command, in response at least in part to receipt at the first port of the command, a response indicating absence of the second port from the switch.

23. The system of claim 22, wherein:
the system further comprises storage; and
the device comprises a controller to control, at least in part, the storage.

24. The system of claim 23, further comprising:
one or more communication links capable of coupling the controller to the storage.

25. The system of claim 23, wherein:
the storage comprises a redundant array of inexpensive disks (RAID).

26. The system of claim 22, wherein:
the issuer comprises the first processor.
